(19) United States
(12) Patent Application Publication
(10) Pub. No.: US 2025/0088228 A1
(43) Pub. Date: Mar. 13, 2025

(54) CHANNEL STATE INFORMATION UPSAMPLING IN WIRELESS COMMUNICATION NETWORK

(71) Applicant: Samsung Electronics Co., Ltd., Suwon-si (KR)

(72) Inventors: Yu-Chien Lin, Davis, CA (US); Yan Xin, Princeton, NJ (US); Yong Ren, Warren, NJ (US); Jianzhong Zhang, Dallas, TX (US)

(21) Appl. No.: 18/822,038

(22) Filed: Aug. 30, 2024

Related U.S. Application Data
(60) Provisional application No. 63/538,156, filed on Sep. 13, 2023.

(51) Int. Cl. H04B 7/0456; H04B 7/06

(52) U.S. Cl. CPC H04B 7/0456; H04B 7/0626

(57) ABSTRACT

Methods and apparatuses for an operation for a channel state information upsampling in a wireless communication system. A method of BS includes: receiving, from a UE, feedback information including at least one SB level precoder; identifying, based on the at least one SB level precoder, a mapping function to perform an up-sampling operation; performing, based on the mapping function, the up-sampling operation to the at least one SB level precoder; and identifying, based on the up-sampling operation, at least one RB level precoder from the at least one SB level precoder for a precoder gain of the BS.

### CROSS-REFERENCE TO RELATED APPLICATIONS AND CLAIM OF PRIORITY

The present application claims priority to U.S. Provisional Patent Application No. 63/538,156, filed on Sep. 13, 2023. The contents of the above-identified patent documents are incorporated herein by reference.

### TECHNICAL FIELD

The present disclosure relates generally to wireless communication systems and, more specifically, the present disclosure relates to a channel state information (CSI) upsampling in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to an operation for a CSI upsampling in a wireless communication system.

In one embodiment, a base station (BS) in a wireless communication system is provided. The BS comprises a transceiver configured to receive, from a user equipment (UE), feedback information including at least one subband (SB) level precoder. The BS further comprises a processor operably coupled to the transceiver, the processor configured to: identify, based on the at least one SB level precoder, a mapping function to perform an up-sampling operation, perform, based on the mapping function, the up-sampling operation to the at least one SB level precoder, and identify, based on the up-sampling operation, at least one resource block (RB) level precoder from the at least one SB level precoder for a precoder gain of the BS.

In another embodiment, a method of BS in a wireless communication system is provided. The method comprises: receiving, from a UE, feedback information including at least one SB level precoder; identifying, based on the at least one SB level precoder, a mapping function to perform an up-sampling operation; performing, based on the mapping function, the up-sampling operation to the at least one SB level precoder; and identifying, based on the up-sampling operation, at least one RB level precoder from the at least one SB level precoder for a precoder gain of the BS.

In yet another embodiment, a UE in a wireless communication system, the UE comprises a processor and a transceiver operably coupled to the processor, the transceiver configured to transmit, to a BS, feedback information including at least one SB level precoder, wherein: a mapping function is identified to perform an up-sampling operation based on the at least one SB level precoder, the up-sampling operation is performed to the at least one SB level precoder based on the mapping function, and at least one RB level precoder is identified from the at least one SB level precoder for a precoder gain of the BS based on the up-sampling operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of. A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of precoder feedback process according to embodiments of the present disclosure;

FIG. 7 illustrates an example of precoder upsampling problem according to embodiments of the present disclosure;

FIG. 8 illustrates a flowchart of SB-level precoder feedback in a frequency-division duplexing (FDD) system according to embodiments of the present disclosure;

FIG. 9 illustrates an example of multi-RB precoding according to embodiments of the present disclosure;

FIG. 10 illustrates an example of aliasing effects according to embodiments of the present disclosure;

FIG. 11 illustrates an example of multipath component reciprocity according to embodiments of the present disclosure;

FIG. 12 illustrates a flowchart of revealed rule-based precoder upsampling according to embodiments of the present disclosure;

FIG. 13 illustrates a flowchart of revealed learning-based precoder upsampling according to embodiments of the present disclosure;

FIG. 14 illustrates a flowchart of network architecture for neural network according to embodiments of the present disclosure;

FIG. 15 illustrates an example of histogram of channels samples based on root mean squared (RMS) delay spread and three clusters separated by the RMS delay spreads according to embodiments of the present disclosure;

FIG. 16 illustrates a flowchart of SB-level precoder feedback in a FDD system with consideration of imperfect channel estimation according to embodiments of the present disclosure;

FIG. 17 illustrates a flowchart of revealed learning-based precoder upsampling with UL CSI denoising according to embodiments of the present disclosure;

FIG. 18 illustrates an example of side effect of partial spectrum usage in a sensor network according to embodiments of the present disclosure;

FIG. 19 illustrates an example of partial spectrum for a sensor network according to embodiments of the present disclosure; and

FIG. 20 illustrates a flowchart of BS method for CSI up-sampling according to embodiments of the present disclosure.

### DETAILED DESCRIPTION

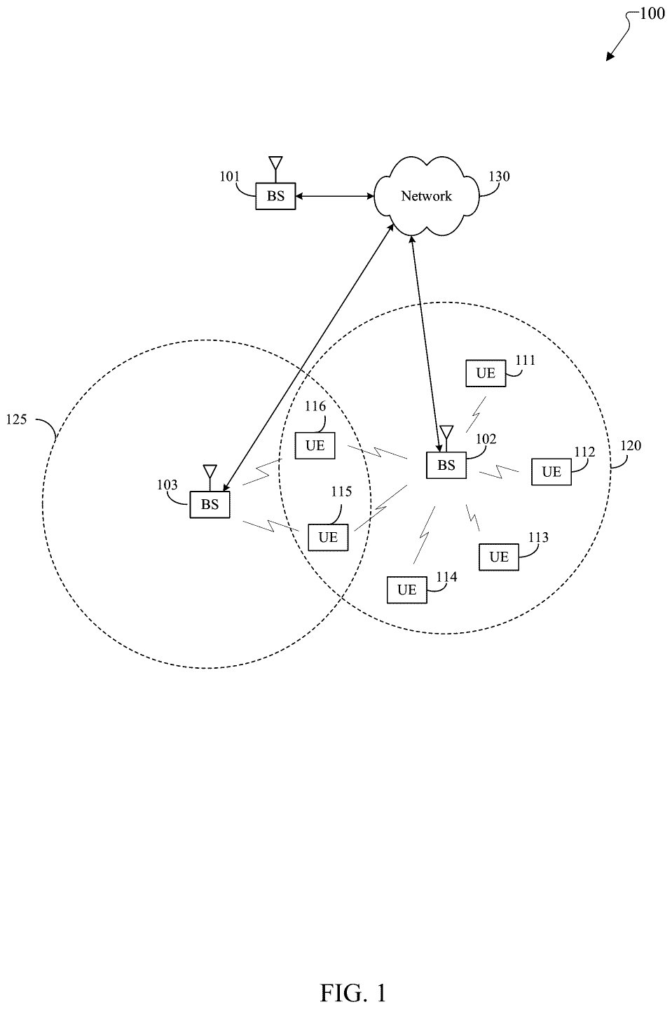

FIGS. 1-20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and channel coding”; 3GPP TS 38.213 v16.1.0, “NR; Physical layer procedures for control”; 3GPP TS 38.214 v16.1.0, “NR; Physical layer procedures for data”; and 3GPP TS 38.331 v16.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (e.g., a gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an operation for CSI upsampling in a wireless communication system. In certain embodiments, and one or more of the gNBs 101-103 includes circuitry, programing, or a combination thereof, for supporting operations for CSI upsampling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

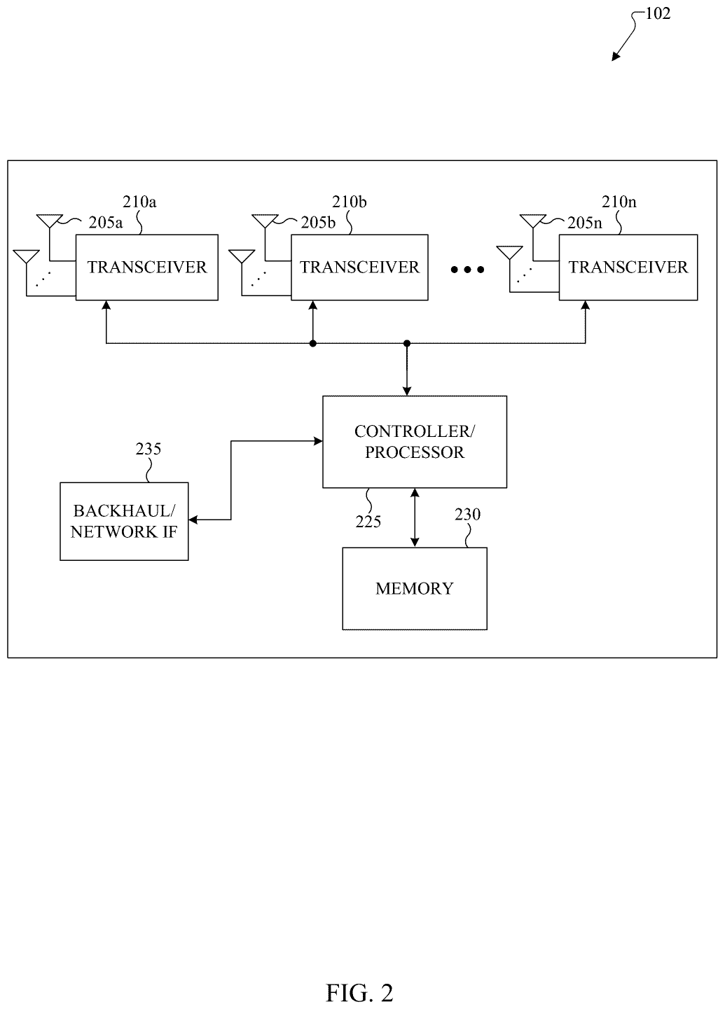

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting an operation for CSI upsampling in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

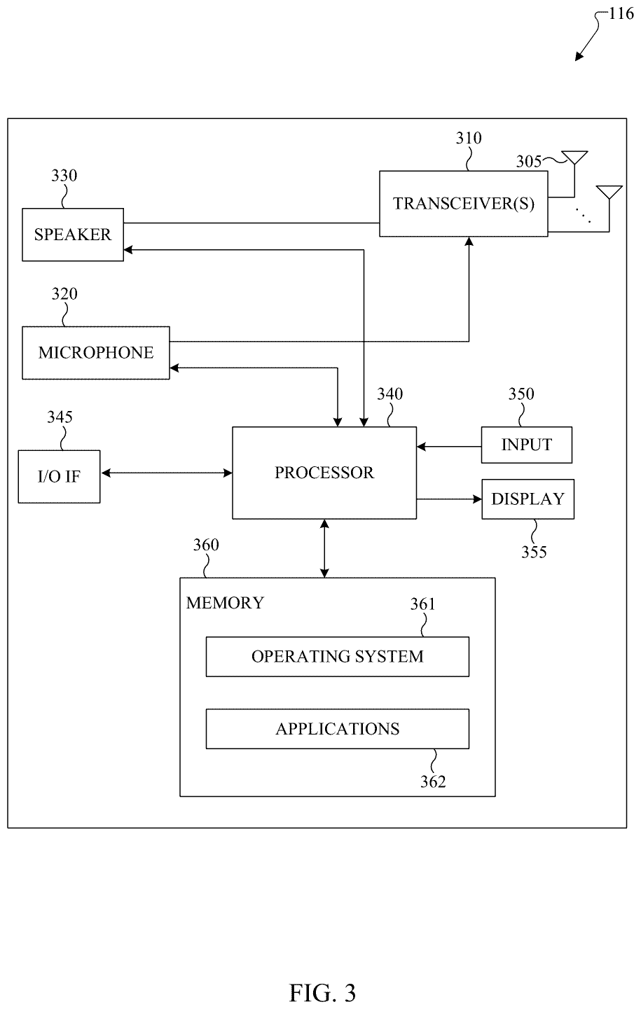

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for CSI upsampling in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

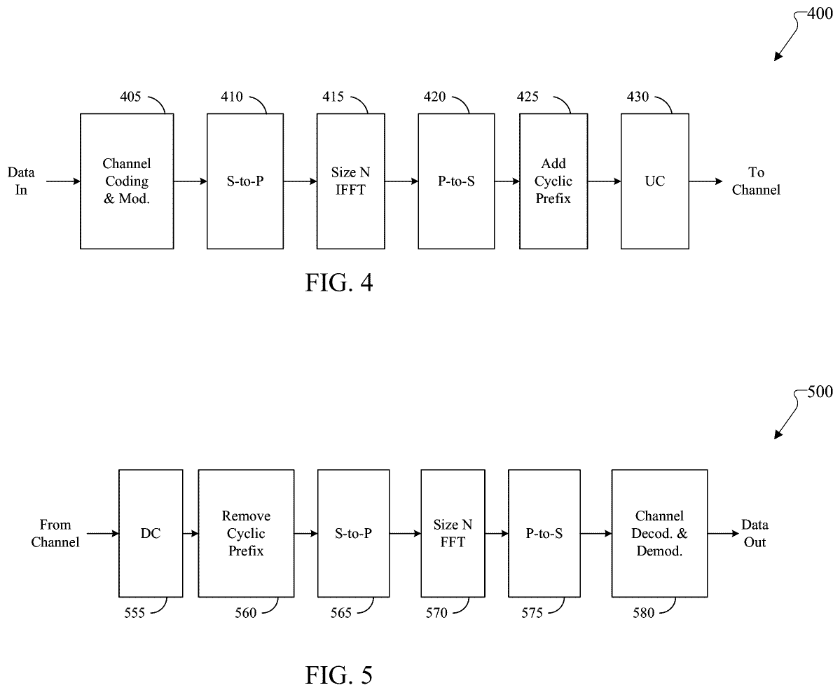

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support an operation for CSI upsampling in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

To fully exploit the advantage of MIMO technology, it is important to acquire accurate CSI for precoder design to maximize the downlink (DL) channel gain. Unlike time-division duplexing (TDD) system, channel reciprocity does not hold among uplink (UL) and DL CSIs in a FDD system. It relies on either implicit or explicit DL CSI feedback from users.

As an operating frequency increases, a new cellular system exploits the advantage of massive MIMO technology to achieve higher energy and spectrum efficiency. Meanwhile, the increased number of antennas also significantly raise the feedback overhead. To minimize the feedback overhead, in current 5G cellular network, a user equipment sends an implicit CSI feedback per subband (SB) instead of per resource block (RB) for UL feedback overhead reduction, however, leading to precoder gain degradation severely under channels with frequency selective fading.

In some cases, there can be learning-based CSI feedback. Its feedback efficiency can outperform standardized approaches such NR type I and type II and other compressive-sensing-based solutions. However, most approaches treat the deep learning model just as a black box for compression and recovery. This type of methods tends to suffer from low generalization ability. In the present disclosure, a physic-inspired learning-based approach is provided to find a mapping from low-resolution CSI feedback to its high-resolution version for maximizing the precoder gain with limited CSI feedback.

In FDD cellular networks, user terminals estimate DL CSI according to reference signals, calculate the optimal/suboptimal precoder and feed back to BS for enhancing DL spectrum efficiency. With the increasing operating frequency in modern communications systems, the size of feedback overhead significantly increases accordingly. Due to the limited air resources, user terminals are not allowed to feedback full-resolution precoders to BS. Instead, they feedback precoders in a subband-level instead of resource-block (RB)-level resolution. This may lead to severe performance degradation in terms of DL channel gain under channels with large delay spread (such as common outdoor channels). Thus, operators aim to design a non-linear mapping function at BS from SB-level precoders to RB-level ones. However, the down sampling from RB-level to SB-level precoder sometimes cause aliasing phenomenon which is theoretically irretrievable. It is not possible to find a perfect mapping from RB-level to SB-level precoder.

This disclosure describes methods to find a mapping function at BS from RB-level precoder to SB-level precoder by introducing deep learning to properly leverage side knowledge, which is available at BS. The side knowledge can be previous DL CSI, instantaneous UL CSIs or other information with smaller frequency sampling interval than SB bandwidth. Due to multipath component reciprocity (i.e., paths with similar directions and delays), the side information is utilized to suppress aliasing effects. In this approach, user terminals only need to feed back downsampled RB-level precoders to BS and do not have extra processing. Then, BS recovers the high-quality RB-level precoder based the provided framework with the side information to deal with aliasing effects.

The present disclosure provides: (1) a new framework for BS to recover RB-level precoders from SB-level ones for enhancing the precoder gain, (2) a new methodology that exploits side information to deal with aliasing issue due to downsampling. The side information can be uplink and past CSI. It can also be information related to BS-UE distance, multipath delays, directions of the UE of interest, or adjacent UEs; and (3) a new physics-inspired neural network framework which can properly incorporate non-aliasing side information to effectively suppress aliasing peaks due to downsampling.

The present disclosure further provides: (1) providing a framework for a BS to recover RB-level precoders from SB-level precoders for enhancing a precoder gain′ and (2) utilizing side information to take advantage of necessary information to design a filter for precoder or CSI up-sampling and aliasing suppression, wherein the side information is associated with at least one of uplink CSI, historical CSI, BS-UE distance, multipath delay, or a UE direction.

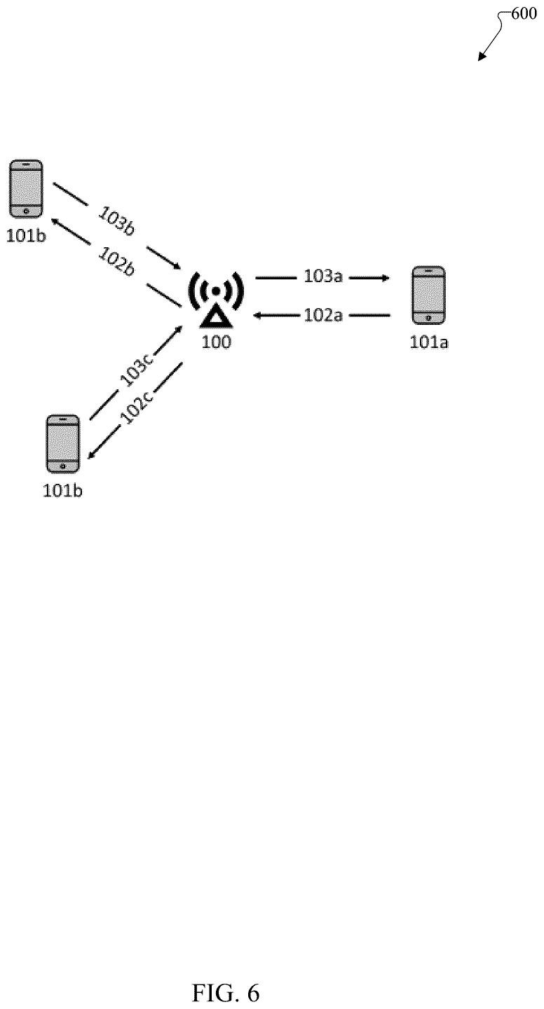

FIG. 6 illustrates an example of precoder feedback process 600 according to embodiments of the present disclosure. An embodiment of the precoder feedback process 600 shown in FIG. 6 is for illustration only.

As illustrated in FIG. 6, a BS 100 sends an RB-level reference signal via the interface 102a, 102b, 102c to multiple user terminals 101a, 101b, and 101c. Then, the user terminals calculate the optimal RB-level precoder according to the estimated channels obtained from the reference signals and feed back to BS via the interface 103a, 103b, and 103c.

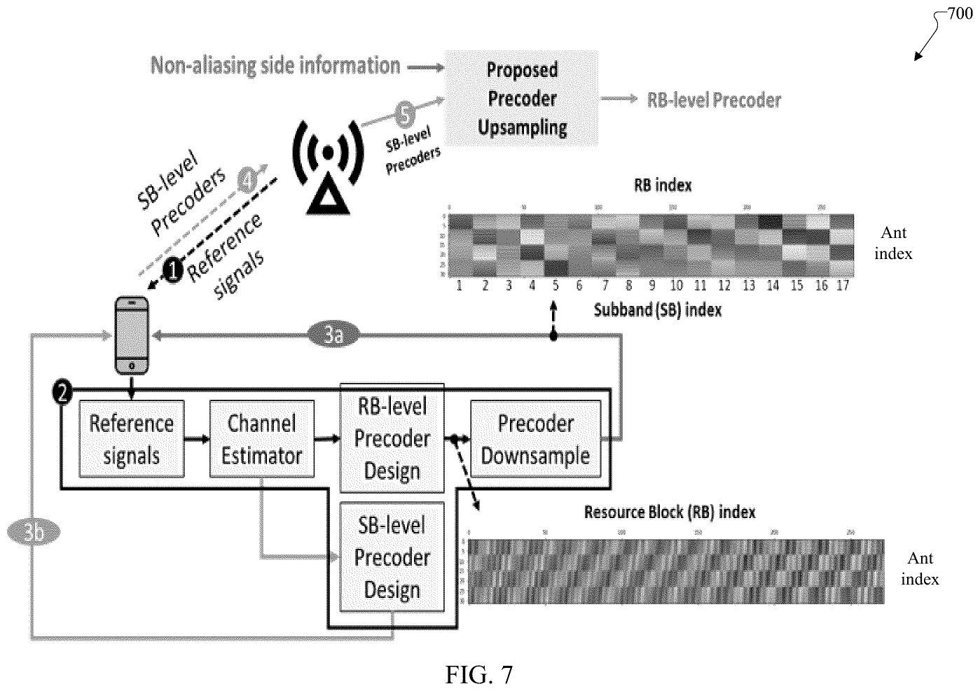

FIG. 7 illustrates an example of precoder upsampling problem 700 according to embodiments of the present disclosure. An embodiment of the precoder upsampling problem 700 shown in FIG. 7 is for illustration only.

Specifically, in order to reduce an uplink feedback overhead, user terminals can either downsample RB-level precoder (3a) or calculate SB-level precoder (3b) and send the precoder (3a or 3b) back to BS. However, these are generally harmful to the acquisition of full channel gain under channels with large delay spread (i.e., large channel variation in frequency domain). Therefore, it is important to provide a solution that can recover RB-level precoder from SB-level precoder so that it cannot only reduce the uplink feedback overhead but also maintain the channel gain obtained from RB-level precoders.

In some embodiments, the present disclosure includes: (1) providing a new framework for BS to recover RB-level precoders from SB-level ones for enhancing the precoder gain; (2) providing a new methodology that exploits side information to deal with aliasing issue due to downsampling; the side information can be uplink and historical CSI; it can also be information related to BS-UE distance, multipath delays, directions of the UE of interest, or adjacent UEs; and (3) providing a physic-inspired neural network framework which can properly incorporate non-aliasing side information to effectively suppress aliasing peaks due to downsampling.

The present disclosure provides the overall operating principle of the system. The present disclosure illustrates the principle and should not be considered as restrictive to the possible embodiments. The different operations and associated embodiments are described in more detail in the following sections.

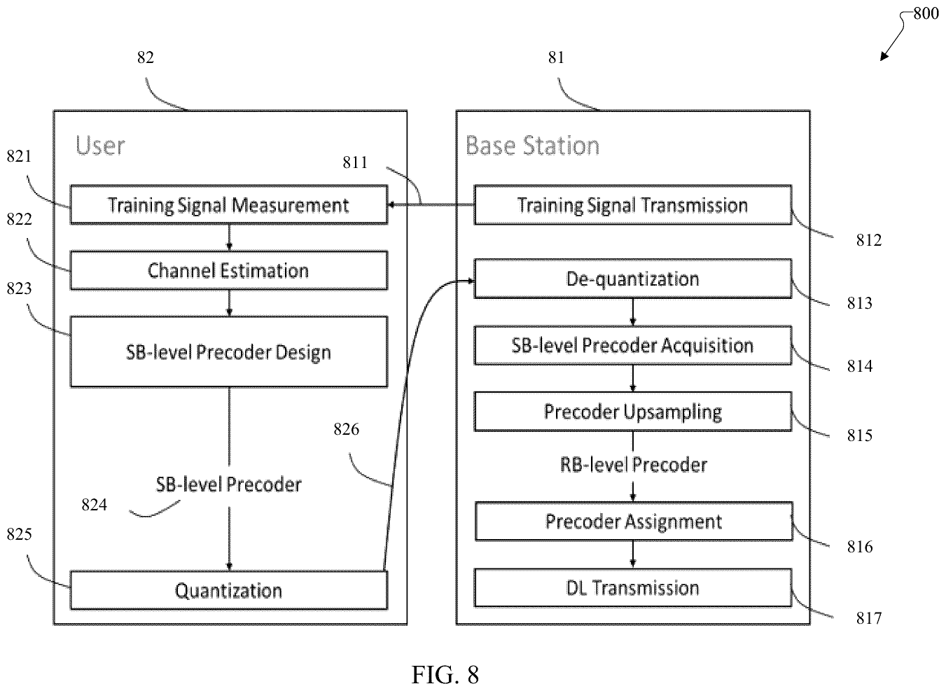

FIG. 8 illustrates a flowchart of SB-level precoder feedback in FDD system 800 according to embodiments of the present disclosure. The SB-level precoder feedback in FDD system 800 as may be performed by a UE (e.g., 111-116 as illustrated in FIG. 1) and a base station (e.g., 101-103 as illustrated in FIG. 1). An embodiment of the SB-level precoder feedback in FDD system 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

The overall system procedure may involve two types of entities: (1) base station 81 and (2) user terminal 82 as illustrated in FIG. 8. In step 812, the base station 81 transmits reference signals in step 811 to user terminals 82 for channel estimation at a user side. In step 821, users 82 measured the reference signals and use LS method to estimate DL CSI in step 822. In step 823 (e.g., SB-level precoder design), there are two different ways as shown below examples.

In one example, a user 82 then designs RB-level precoders (note that RB-level DL CSI is equivalent to RB-level DL precoder for non-codebook-based precoder feedback, resulting in the same channel gain. In the following parts, it may interchange the terms precoder and CSI) and feedback it back per SB (SB-level precoder 824) to the base station 81 after down-sampling and quantization in step 825.

In one example, a user 82 then designs SB-level precoders and directly feedback to a base station after quantization in step 825.

Then, the base station 81 upsamples the SB-level precoder to RB-level precoder. The base station then acquires SB-level precoder after de-quantization in step 813 and to up-sample the SB-level precoder as RB-level precoder by following step 815. In step 816, the BS assigns the RB-level precoders to different RBs to enhance SNR of DL transmission in step 817. The present disclosure focuses on the development of step 815, which is precoder upsampling.

The present disclosure provides a way that can be termed as multi-RB precoding in the present disclosure, as the baseline for comparison with the provided approach. This method is an optimal solution when considering perfect DL CSI estimation. Without loss of generality, it is considered that a base station with Nₐ antennas communicates with a single-antenna UE. The DL CSI at the i-th RB can be expressed as hᵢ ∈ [symbol] ^{N}^{ₐ},i=1,2, . . . ,N_{RB}, where N_{RB} is the number of RBs in a BWP. There are N_{RBpSB} RBs in an SB. Namely, this approach feeds back a precoder per SB (per N_{RBRsB}). The precoder for the j-th SB is given by:

$${f}_{j} = V ( : , 1 ) \qquad ( 1 )$$

$${R}_{j} = {\sum }_{i ∈ {Ω}_{j}} {h}_{i} {h}_{i}^{H} = {U}_{j}^{H} {\sum }_{j} {V}_{j} \qquad ( 2 )$$

In such equations, Rⱼ is the spatial covariance matrix for the j-th SB and Ωⱼ is the index set of RBs in the j-th SB.

Uⱼ, Σⱼ and Vⱼ are Rⱼ's left singular vector, singular value and right singular vector matrices, respectively. An optimal precoder is provided by taking SVD on the spatial covariance matrix and find the singular vector corresponding to the largest singular value. This approach can be straightforward. However, intrinsically, it is a “downsampling” process by a factor of N_{RBRsB}. Thus, the channel gain may degrade severely when considering a highly frequency selective channel or adopting a too large downsampling rate N_{RBpSB}.

To evaluate the channel gain obtained from precoders, a new metric is provided that is called normalized channel gain (NCG) which is the complex cosine similarity between channels h and precoder f as given below:

$$NCG = \frac{\vert {h}^{H} f \vert}{‖ h \vert \vert ‖ f ‖} \qquad ( 3 )$$

The nominator|h^{H}f| represents the actual channel gain obtained from the precoder and the denominator aims to normalize the channel and the precoder.

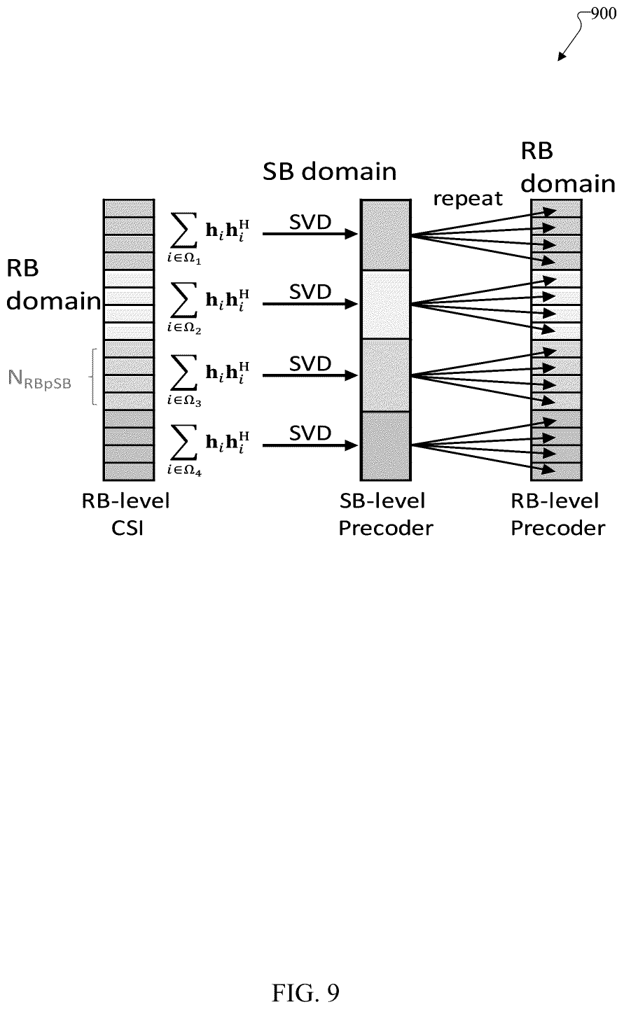

FIG. 9 illustrates an example of multi-RB precoding 900 according to embodiments of the present disclosure. An embodiment of the multi-RB precoding 900 shown in FIG. 9 is for illustration only.

TABLE 1 shows the normalized channel gain performance of the baseline, multi-RB precoding, for different N_{RBpSB} and testing samples with different degrees of frequency selectivity.

TABLE 1
Normalized channel gain (NCG) of the baseline approach for different
clusters and N_{RBpSB} (considering two user antennas).

| | ALL = CL1 + | CL1 | CL2 | CL3 |
|---|---|---|---|---|
| | CL2 + CL3 | (Low DS) | (Medium DS) | (Large DS) |
| N_{RBpSB} = 4 | 0.9215 | 0.9882 | 0.9236 | 0.8462 |
| N_{RBpSB} = 8 | 0.8899 | 0.9688 | 0.8789 | 0.8154 |
| N_{RBpSB} = 16 | 0.8637 | 0.9399 | 0.8480 | 0.7973 |
| N_{RBpSB} = 32 | 0.8436 | 0.9111 | 0.8285 | 0.7861 |

The present disclosure provides, when DL CSI is perfect, an improved approach since this approach can increase the channel gain in a specific SB by choosing the singular vector corresponding to the largest singular value. Namely, following equation is obtained:

$${V}_{j} ( : , 1 ) = \begin{matrix}arg max \\ x\end{matrix} \{ {x}^{H} {R}_{j} x = {\sum }_{i ∈ {Ω}_{j}} {x}^{H} {h}_{i} {h}_{i}^{H} x ⊂ {\sum }_{i ∈ {Ω}_{j}} {NCG}_{i}^{2} \} \qquad ( 4 )$$

It shows that the singular vector is the optimal solution for this problem if the DL CSI is perfect and there is not any side information. To improve the performance, powerful deep learning models may be directly used for super-resolution tasks in computer vision area to do the precoder upsampling task which inputs the optimal precoders from the baseline approach and outputs precoders for better channel gains based on channel priors. It may select two algorithms, information multi-distillation network (IMDN) and hybrid network of CNN and transformer (HNCT) as benchmark algorithms.

IMDN uses a multi-distillation block to extract features progressively which balance the performance and the computation cost. At NTIRE 2022 efficient SR challenge, IMDN gets the second-best overall performance. HNCT integrates both CNN and attention mechanism and the HNCT achieves second best PSNR and the least activation operations in NTIRE 2022 efficient SR challenge.

Both algorithms are lightweight and suitable for embedded systems. Unlike the traditional super resolution algorithms which increase the size of the low-resolution image before fed to the network, the selected two algorithms use the original low-resolution images as input and increase the output resolution by sub-pixel convolution at the end of the networks which further reduce the computation cost. However, the results of the present disclosure show that it is not possible to improve significantly over the baseline.

TABLE 2 shows the performance of NCG for the baseline approach, IMDN and HNCT. It may be found that only minor or no performance improvement can be obtained from using the powerful deep learning models. Thus, it may be concluded that there is no channel prior which can be used to solve aliasing problem. To solve aliasing problem due to downsampling, extra non-aliasing information may be included.

TABLE 2
NCG performance of the baseline approach, IMDN and HNCT for
N_{RBpSB} = 4, 8 and 16 (considering one user antenna only).

| Experiments | Methods | NGC (ALL CLs) |
|---|---|---|
| Down sampling | IMDN | 0.9141 |
| N_{RBpSB} = 4 | HNCT | 0.9132 |
| | Baseline | 0.9129 |
| Down sampling | IMDN | 0.8808 |
| N_{RBpSB} = 8 | HNCT | 0.8812 |
| | Baseline | 0.8812 |
| Down sampling | IMDN | 0.8551 |
| N_{RBpSB} = 16 | HNCT | 0.8552 |
| | Baseline | 0.8546 |

In one embodiment, the method to exploit UL CSI information for precoder upsampling will first be demonstrated and verified by simulation results. This section describes the core of the first embodiment.

[symbol]

For an arbitrary signal X∈ [symbol] ^{N} in frequency domain and its downsampled signal

$${X}_{D S} = X [ 0 ∶ ∶ D ] ∈ {ℂ}^{\frac{N}{D}} ,$$

given DFT shifting property, after IDFT transformation, the two signals in delay domain have the following relationship:

$${x}_{D S} [ n ] = \frac{( x [ n ] + x [ n + \frac{N}{D} ] + x [ n + \frac{2 N}{D} ] + … )}{D} \qquad ( 5 )$$

If x[n]≠0 for any n≥N/D, aliasing effect occurs after downsampling, and it cannot be recovered to the original version in general cases. However, x[n]can be perfectly recovered if x[n]satisfies the following two requirements: (1) bin isolation property: only one of x[n]+x[n+N/D]+x[n+2N/D]+ . . . is non-zero. Namely, the wrapped-around bins and low-delay bin do not collide to each other. In this case, the original signal is mapped by extracting the value in x_{DS} [n]if the delay of each bin is perfectly known; and (2) knowledge of delays in original signal.

FIG. 10 illustrates an example of aliasing effects 1000 according to embodiments of the present disclosure. An embodiment of the aliasing effects 1000 shown in FIG. 10 is for illustration only.

As illustrated in FIG. 10, it demonstrates a toy example to recover a signal after downsampling by a factor of two if there is perfect knowledge of the delay profile.

In general, this delay information is impossible to have if there is no original signal X. However, in communications systems, the original signal X, which is DL CSI, is highly correlated to UL CSI, which is locally available at BS, in terms of magnitudes in delay and angle domains. Although DL and UL CSIs are not correlated in FDD wireless system, as shown in FIG. 10, their large-scale multipath geometries are identical, leading to similar delay and angle profile, also verified by field tests [3, 4].

Although the delay profile of DL CSI may not be known, it may still access a good estimate from evaluating delay profile of UL CSI. If it can make sure there is no aliasing effect in UL CSI, then it can design a bandpass filter in delay and angle domain to suppress the aliasing effects. In modern communications systems, the reference signal density in frequency domain for UL CSI estimation is much higher than the pilot density for DL CSI. Thus, no aliasing effect occurs in UL CSI. This disclosure provides to conduct precoder upsampling by leveraging UL CSI to deal with aliasing effects.

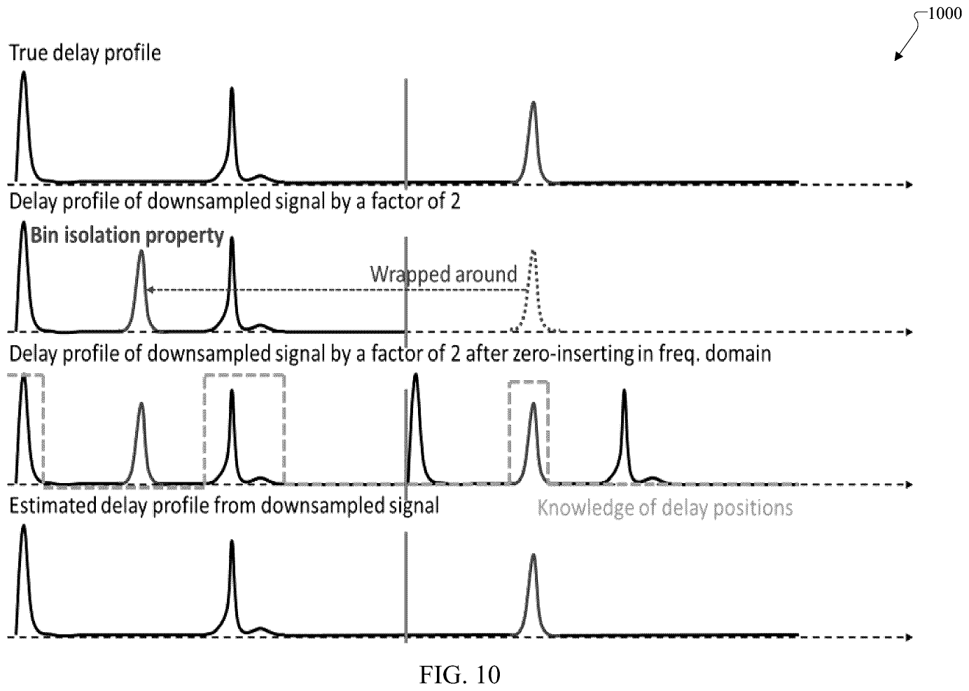

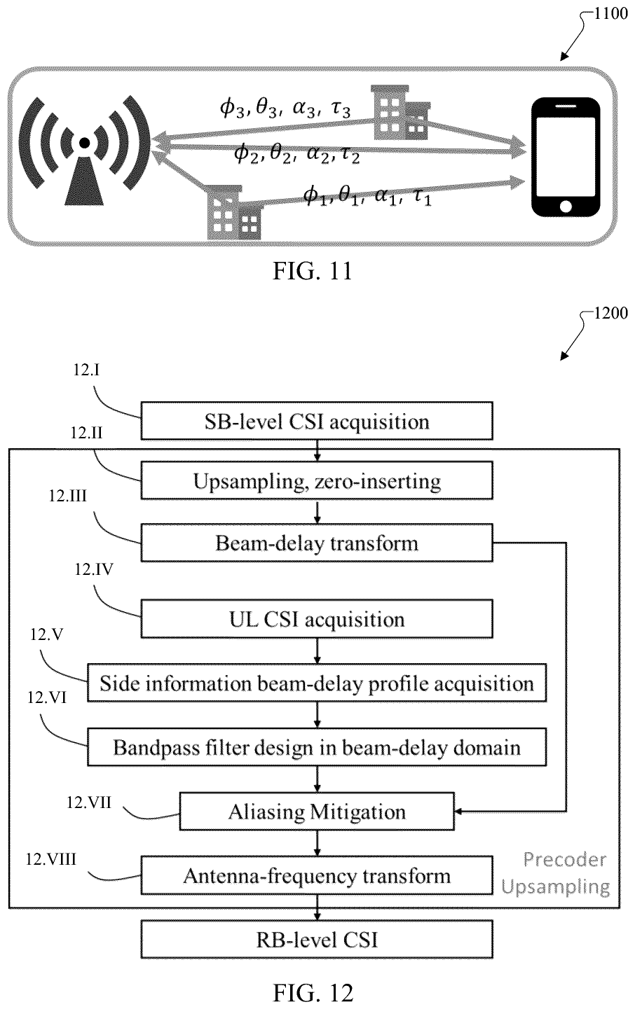

FIG. 11 illustrates an example of multipath component reciprocity 1100 according to embodiments of the present disclosure. An embodiment of the multipath component reciprocity 1100 shown in FIG. 11 is for illustration only.

FIG. 12 illustrates a flowchart of revealed rule-based precoder upsampling 1200 according to embodiments of the present disclosure. The revealed rule-based precoder upsampling 1200 as may be performed by a BS (e.g., 101-103 as illustrated in FIG. 1). An embodiment of the revealed rule-based precoder upsampling 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

In some embodiments, the BS does not apply deep learning approach to exploit UL CSI by MPC for upsampling. The flow diagram of the BS entity operation in is illustrated in FIG. 12. Note that all of these steps may not be followed in all embodiments. In steps 12.1 and 12.11, a BS received SB-level DL CSI from UEs and upsampled the SB-level DL CSI by zero-inserting. In step 12.111, the SB-level DL CSI is transformed into beam-delay domain for exploiting MPC between UL and DL CSIs. In step 12.IV, the entity accessed the locally available UL CSI by channel estimation.

In step 12.V, the entity transforms UL CSI into the magnitude of UL CSI in angle-time domain. In step 12.VI, the entity calculates a bandpass map according to the magnitude of UL CSI in beam-delay domain by a hard-thresholding approach. In step 12.VII, the entity then applies the bandpass map to the angle-time domain DL CSI. In step 12.VIII, the BS transforms the resulting DL CSI back to spatial-frequency domain.

In a mathematical representation, it can express the SB-level CSI as H_{SB} ∈ [symbol] ^{N}^{ₐ}^{×N}, where Nₐ and N are the numbers of antennas and SBs, resepctively. It then performs zero-inserting to the SB-level CSI in the frequency domain by a factor of N_{RBpSB} to match the number of RBs (N_{RB}=NN_{RBpSB}). This zero-inserted SB-level CSI can be represented as:

$${H}_{SB , zp} = [ {H}_{SB} ( : , 1 ) , 0 , … , 0 , {H}_{SB} ( : , 2 ) , 0 , … , 0 , {H}_{SB} ( : , 3 ) … {H}_{SB} ( : , N ) , 0 , 0 , 0 ] . \qquad ( 6 )$$

In equation 6, where 0 is an all-zero column vector with size of Na and there are N−1 0 between consecutive non-zero vectors. Then it may be transformed into beam-delay domain via IDFT operations, which is given by:

$${H}_{SB , zp , BD} = {F}_{B A}^{H} {H}_{SB , zp} {F}_{F D} \qquad ( 7 )$$

In equation 7, F_{BA}∈ [symbol] ^{N}^{ₐ}^{×N}^{ₐ} and F_{FD} ∈, [symbol] ^{N×N} are IDFT matrices for transformation into beam and delay domains, respectively. Due to the zero-inserting operation, H_{SB},zp,_{BD} becomes a map with repetitive patterns in delay domain, where aliasing and non-aliasing peaks both exist in the map. From equation (5), it may be also known that the value of the k-th beam and n-th delay in H_{SB,zp,BD}can be represented as:

$${H}_{SB , zp , BD} [ k , n ] = \frac{( {H}_{R B , B D} [ k , n ] + {H}_{RB , BD} [ k , n + \frac{N}{D} ] + {H}_{RB , BD} [ k , n + \frac{2 N}{D} ] + … )}{D} \qquad ( 8 )$$

In equation 8, where H_{RB,BD} is the RB-level DL CSI which is our target. When bin isolation property is valid, if it may know that which beam-delay bin in H_{RB,BD} has non-zero value, it may suppress the aliasing peaks and remain the non-aliasing peaks. To do so, it may need to design a bandpass filter in beam-delay domain with the knowledge of |H_{RB,BD} |.

It can express the RB-level UL CSI as H_{RB, UL} ∈ [symbol] ^{N}^{ₐ}^{×}^{NN}^{_{RBpSB}} and its beam-delay version as H_{RB.UL,BD}=F_{BA}^{H}H_{RB.UL}F_{FD}. According to MPC reciprocity, it may know DL CSI magnitude in beam-delay domain |H_{RB,BD} | and UL CSI magnitude in beam-delay domain |H_{RB,UL,BD} | are highly correlated. |H_{RB,UL,BD} | may be a perfect material to design the bandpass filter for suppressing the aliasing effect in DL CSI.

To design a bandpass filter according to |H_{RB,UL,BD} |, it may apply a hard-thresholding approach given by:

$$M [ k , n ] = \{ \begin{matrix}1 , if \vert {H}_{RB , UL , BD} [ k , n ] \vert \geq t \\ 0 , if \vert {H}_{RB , UL , BD} [ k , n ] \vert < t\end{matrix} \qquad ( 9 )$$

In equation 9, t is a hyperparameter which is proportional to the average power of H_{RB,UL,BD}. Then it may apply the bandpass filter M to H_{SB,zp,BD} to conduct aliasing mitigation and get the estimate of H_{RB,BD} as given by:

$${\hat{H}}_{R B , B D} = {H}_{SB , zp , BD} ∘ M \qquad ( 10 )$$

In equation 10, o is an element-wise multiplication operator.

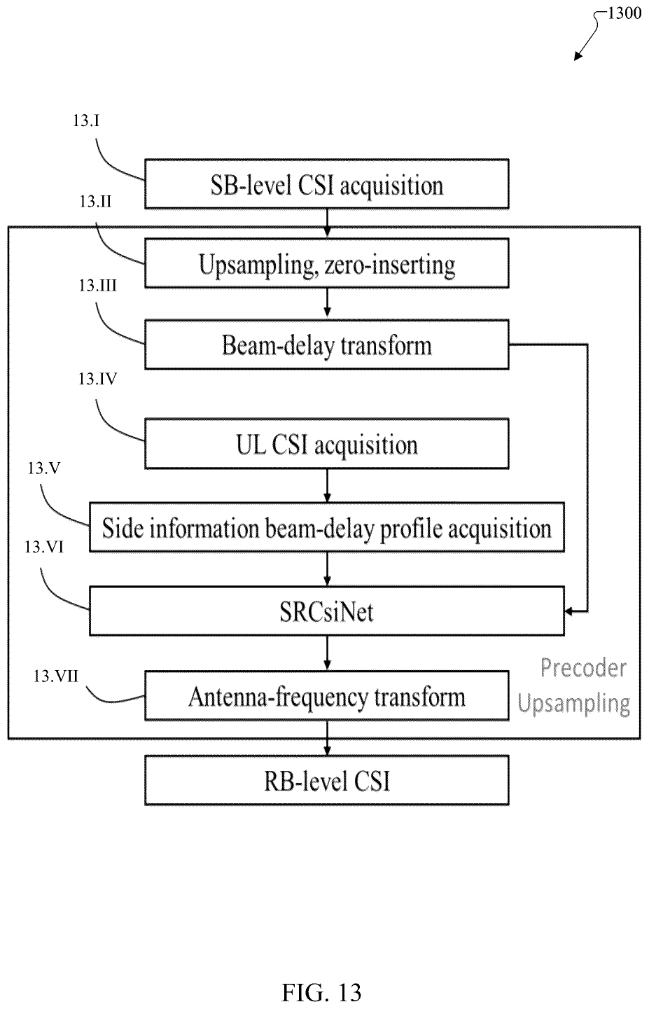

In some embodiments, a convolutional deep learning model can replace steps 12.VI and 12.VII for aliasing mitigation and further DL CSI refinement. The flow diagram of the BS entity operation in is illustrated in FIG. 13.

FIG. 13 illustrates a flowchart of revealed learning-based precoder upsampling 1300 according to embodiments of the present disclosure. The revealed learning-based precoder upsampling 1300 as may be performed by a BS (e.g., 101-103 as illustrated in FIG. 1). An embodiment of the revealed learning-based precoder upsampling 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

Note that all of these steps may not be followed in all embodiments. In steps 13.1 and 13.11, A BS received SB-level DL CSI from UEs and upsampled SB-level DL CSI by zero-inserting. In step 13.111, the SB-level DL CSI is transformed into angle-time domain for exploiting MPC between UL and DL CSIs. In step 13.IV, the entity accessed the locally available UL CSI by channel estimation. In step 13.V, the entity transforms UL CSI into the magnitude of UL CSI in beam-delay domain. In step 13.VI, the entity utilizes a deep learning network to design a bandpass map and refine the upsampled DL CSI. In step 13.VII, the BS transforms the resulting DL CSI back to antenna-frequency domain.

A convolutional deep learning model, called SRCsiNet, used in this embodiment does not restrict to a specific type of model. The model can be constructed with any other layers or modules.

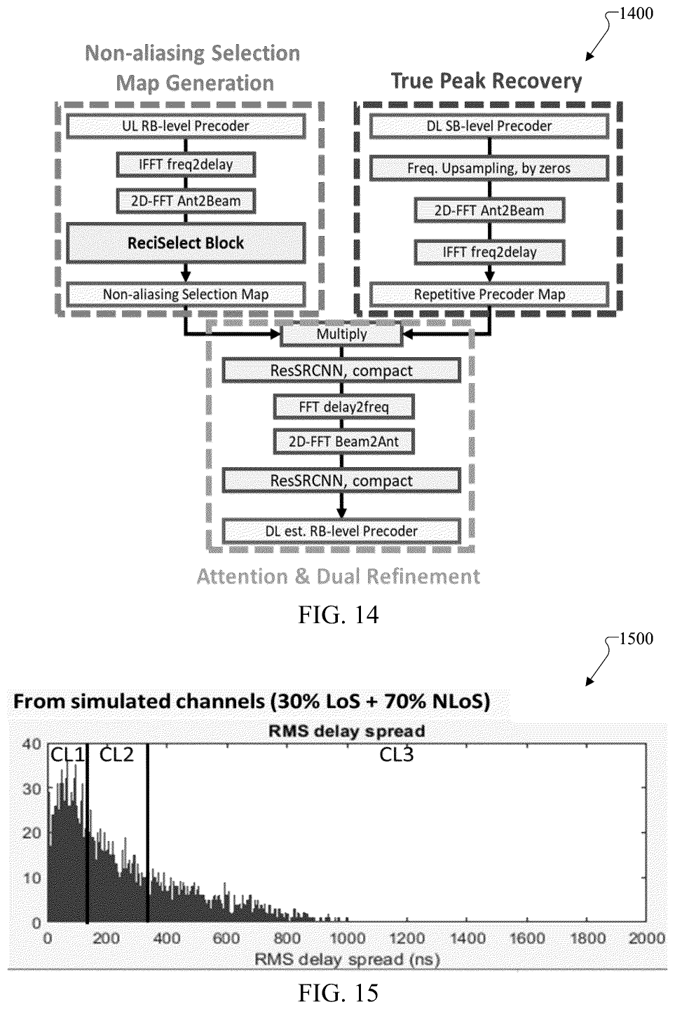

FIG. 14 illustrates a flowchart of neural network 1400 according to embodiments of the present disclosure. The neural network 1400 as may be performed by a UE (e.g., 111-116 as illustrated in FIG. 1) and a BS (e.g., 101-103 as illustrated in FIG. 1). An embodiment of the neural network 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, this model can comprise three modules as shown in examples.

In one example of true peak recovery, this part transforms SB-level CSI into a repetitive CSI map in delay and beam domain. In this domain, according to the equation (5), this map contains both non-aliasing and aliasing peaks. In mathematical representation, it can follow the equations (6), (7) and (8) to get H_{SB,zp,BD}.

In one example of non-aliasing selection map generation, this part aims to design a band ass filter with the same size of the output of true peak recovery part. It may express the RB-level UL CSI as H_{RB.UL} ∈ [symbol] ^{N}^{ₐ}^{×NN}^{_{RBpSB}} and its beam-delay version as H_{RB.UL,BD}=F_{BA}^{H}H_{RB.UL}F_{FD}. Then it may feed the magnitude of H_{RB.UL,BD} into a convolutional neural network to obtain the bandpass filter as given by:

$$M = {f}_{ReciSelect} ( \vert {H}_{R B . UL , BD} \vert ) \qquad ( 11 )$$

In one example of attention and dual refinement, by element-wise multiplication, the bandpass filter nulls those aliasing peaks and remain the true peaks in delay and beam domain. This part aims to further refine the upsampling operation and deal with the imperfections due to the violation of bin isolation property. This part applies two convolutional residual blocks to refine the estimate in dual domain: delay-beam and frequency-antenna domains. In mathematical representation, it may first obtain Ĥ_{RB,BD}=H_{SB,zp,BD} ∘M as the initial estimate. Then the model refines it in dual domains (first in beam-delay then in antenna-frequency domain) as given b

$${\hat{H}}_{RB , BD , 1} = {f}_{Res S R C N N , 1} ( {\hat{H}}_{R B , B D} ) \qquad ( 12 )$$

$$and {\hat{H}}_{R B} = {f}_{ResSRCNN , 2} ( {F}_{A B}^{H} {\hat{H}}_{RB , BD , 1} {F}_{DF} ) \qquad ( 13 )$$

In such equations, F_{BA} ∈ [symbol] ^{N}^{ₐ}^{×N}^{ₐ} and F_{FD}∈ [symbol] ^{N×N} are DFT matrices for transformation into antenna and frequency domains.

[symbol]

FIG. 15 illustrates an example of histogram of channels samples 1500 based on RMS delay spread and three clusters separated by the RMS delay spreads according to embodiments of the present disclosure. An embodiment of the histogram of channels samples 1500 shown in FIG. 15 is for illustration only.

In one embodiment, an approach under channels generated by QuaDRiGa channel simulator is provided. It follows current communication standardized channel model called 3GPP standard specification. The central frequencies of the uplink and downlink transmission is on 4 and 4.1 GHz with bandwidth of 25, 50 and 100 MHz.

As illustrated in FIG. 15, test samples are clustered into 3 groups: low delay-spread (DS), medium DS, and high DS. The provided approach is compared with a baseline which is an optimal approach for SB-level precoder feedback. In the baseline approach, as illustrated FIG. 15, a user calculates the spatial covariance matrix according to the estimated DL CSIs in a subband and extract the right singular vector corresponding to the largest singular value to be the SB-level precoder to be fed back to a BS. Then, the BS assigns the SB-level precoder as precoders of RBs in a SB.

TABLE 3 shows the performance in terms of the normalized gain as compared to the baseline under different numbers of RBs per SB (which can be regarded as downsampling rate in frequency) and bandwidth parts. This table reveals that, by introducing the deep learning network to leverage UL CSI to suppress the aliasing effects, significant improvement can be obtained as compared to the baseline. Especially for cluster 3 (large DS channels), by applying this disclosure, a 14% gain improvement can be obtained.

TABLE 3
Normalized channel gain
For different BWP

| | ALL: CL1 + CL2 + CL3 | | | | CL1: DS <= 130 ns | | | |
|---|---|---|---|---|---|---|---|---|
| No RBs | No SB | 69 | 34 | 17 | No SB | 69 | 34 | 17 |
| per SB = 4 | BWP (MHz) | 100 | 50 | 25 | BWP (MHz) | 100 | 50 | 25 |
| | SRCsiNet | | | | | | | |
| | Normalized | 0.98 | 0.97 | 0.96 | Normalized | 0.99 | 0.99 | 0.99 |
| | Gain | | | | Gain | | | |
| | % outperfm | 6.1 | 5.3 | 4.4 | % outperfm | 0.5 | 0.3 | 0.2 |
| | Baseline | | | | Baseline | | | |
| | ALL: CL1 + CL2 + CL3 | | | | CL1: DS <= 130 ns | | | |
| No RBs | No SB | 34 | 17 | 8 | No SB | 34 | 17 | 8 |
| per SB = 8 | BWP (MHz) | 100 | 50 | 25 | BWP (MHz) | 100 | 50 | 25 |
| | SRCsiNet | | | | | | | |
| | Normalized | 0.96 | 0.94 | 0.93 | Normalized | 0.98 | 0.98 | 0.97 |
| | Gain | | | | Gain | | | |
| | % outperfm | 7.4 | 6.1 | 4.3 | % outperfm | 1.5 | 1.1 | 0.6 |
| | Baseline | | | | Baseline | | | |
| | ALL: CL1 + CL2 + CL3 | | | | CL1: DS <= 130 ns | | | |
| No RBs | No SB | 17 | 8 | 4 | No SB | 17 | 8 | 4 |
| per SB = 16 | BWP (MHz) | 100 | 50 | 25 | BWP | BWP (MHz) | 100 | 50 |
| | SRCsiNet | | | | | | | |
| | Normalized | 0.92 | 0.90 | 0.89 | Normalized | 0.96 | 0.95 | 0.95 |
| | Gain | | | | Gain | | | |
| | % outperfm | 6.7 | 4.6 | 2.9 | % outperfm | 2.0 | 1.0 | 0.8 |
| | Baseline | | | | Baseline | | | |
| | ALL: CL1 + CL2 + CL3 | | | | CL1: DS <= 130 ns | | | |
| No RBs | No SB | 8 | 4 | 2 | No SB | 8 | 4 | 2 |
| per SB = 32 | BWP (MHz) | 100 | 50 | 25 | BWP (MHz) | 100 | 50 | 25 |
| | SRCsiNet | | | | | | | |
| | Normalized | 0.88 | 0.84 | 0.82 | Normalized | 0.92 | 0.90 | 0.88 |
| | Gain | | | | Gain | | | |
| | % outperfm | 4.0 | −0.9 | −3.2 | % outperfm | 1.3 | −1.7 | −3.0 |
| | Baseline | | | | Baseline | | | |

| | CL2: DS = 130-350 ns | | | | CL3: DS >= 350 ns | | | |
|---|---|---|---|---|---|---|---|---|
| No RBs | No SB | 69 | 34 | 17 | No SB | 69 | 34 | 17 |
| per SB = 4 | BWP (MHz) | 100 | 50 | 25 | BWP (MHz) | 100 | 50 | 25 |
| | SRCsiNet | | | | | | | |
| | Normalized | 0.98 | 0.97 | 0.96 | Normalized | 0.96 | 0.94 | 0.93 |
| | Gain | | | | Gain | | | |
| | % outperfm | 6.1 | 5.3 | 4.4 | % outperfm | 13.3 | 11.6 | 9.7 |
| | Baseline | | | | Baseline | | | |
| | CL2: DS = 130-350 ns | | | | CL3: DS >= 350 ns | | | |
| No RBs | No SB | 34 | 17 | 8 | No SB | 34 | 17 | 8 |
| per SB = 8 | BWP (MHz) | 100 | 50 | 25 | BWP (MHz) | 100 | 50 | 25 |
| | SRCsiNet | | | | | | | |
| | Normalized | 0.95 | 0.94 | 0.92 | Normalized | 0.93 | 0.91 | 0.88 |
| | Gain | | | | Gain | | | |
| | % outperfm | 8.4 | 7.0 | 4.8 | % outperfm | 14.0 | 11.5 | 8.4 |
| | Baseline | | | | Baseline | | | |
| | CL2: DS = 130-350 ns | | | | CL3: DS >= 350 ns | | | |
| No RBs | No SB | 17 | 8 | 4 | No SB | 17 | 8 | 4 |
| per SB = 16 | BWP (MHz) | 100 | 50 | 25 | BWP (MHz) | 100 | 50 | 25 |
| | SRCsiNet | | | | | | | |
| | Normalized | 0.91 | 0.90 | 0.88 | Normalized | 0.89 | 0.86 | 0.84 |
| | Gain | | | | Gain | | | |
| | % outperfm | 7.8 | 5.6 | 3.5 | % outperfm | 11.3 | 8.2 | 4.9 |
| | Baseline | | | | Baseline | | | |
| | CL2: DS = 130-350 ns | | | | CL3: DS >= 350 ns | | | |
| No RBs | No SB | 8 | 4 | 2 | No SB | 8 | 4 | 2 |
| per SB = 32 | BWP (MHz) | 100 | 50 | 25 | BWP (MHz) | 100 | 50 | 25 |

| SRCsiNet | | | | | | | |
|---|---|---|---|---|---|---|---|
| Normalized | 0.87 | 0.82 | 0.8 | Normalized | 0.83 | 0.78. | 0.76 |
| Gain | | | | Gain | | | |
| % outperfm | 5.0 | −0.3 | −3.4 | % outperfm | 6.1 | −0.6 | −3.4 |
| Baseline | | | | Baseline | | | |

TABLE 3 shows that normalized channel gain by applying the embodiments in the present disclosure as compared to applying the baseline approach for different numbers of RBs per SB and bandwidths (red and blue colors represent the cases that perform better and worse than the baseline, respectively).

In one embodiment, UL CSJ is considered as the side information for aliasing suppression. In this embodiment, there may be different types of side information. A reason to have side information is to acquire the knowledge of non-aliasing beam and delay positions. Namely, any side information which can provide the knowledge help to suppress aliasing peaks in the provided approach. Other than UL CSI information, the side information can be historical channel estimates, control signal channels, synchronization channels, time-of-arrival (ToA) information, geometrical directional information and other information which contains non-aliasing delay and beam information from the own user or even adjacent users. The information is not restricted to the information which is locally available to BS. It can be compressed or directly fed back from users or obtain from higher-level central units.

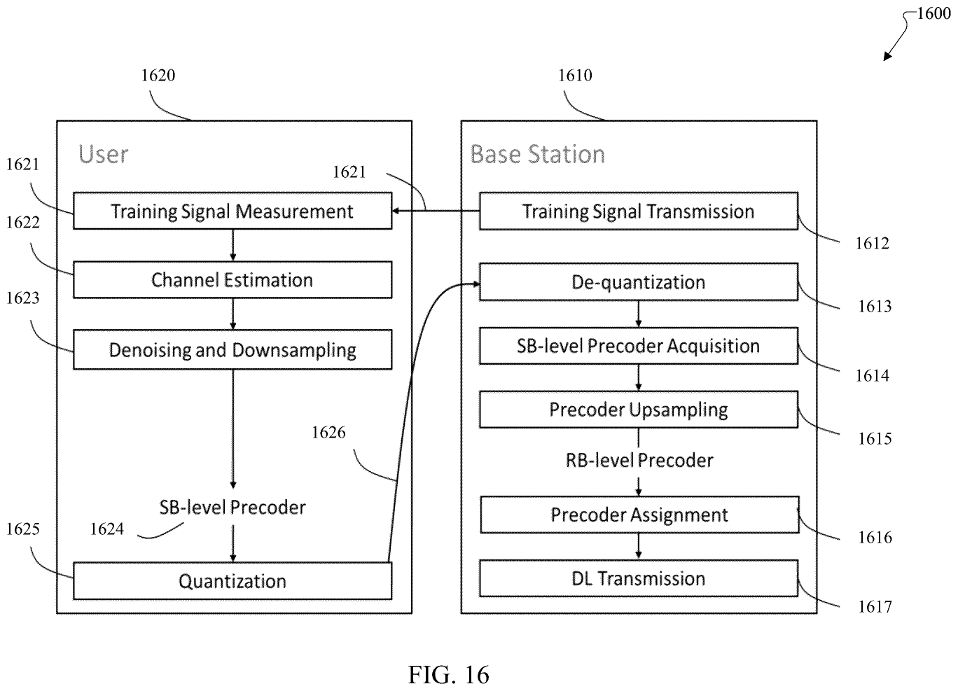

In one embodiment, denoising for DL CSI and side information is provided. In one embodiment, it may demonstrate the provided approach with perfect DL and UL CSI estimation. It may consider the imperfect DL and UL CSI estimation and heterogenous side information. This embodiment is the extension of the embodiment as disclosed in the present disclosure. It can be also applied to the cases mentioned in the second embodiment if applicable. The overall system procedure may involve two types of entities: base stations 121 and user terminals 122 as illustrated in FIG. 16.

FIG. 16 illustrates a flowchart of SB-level precoder feedback in FDD system with consideration of imperfect channel estimation 1600 according to embodiments of the present disclosure. The SB-level precoder feedback in FDD system with consideration of imperfect channel estimation 1600 as may be performed by a UE (e.g., 111-116 as illustrated in FIG. 1) and a BS (e.g., 101-103 as illustrated in FIG. 1). An embodiment of the SB-level precoder feedback in FDD system with consideration of imperfect channel estimation 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

The base station 1610 transmits reference signals to user 1620 (e.g., terminal or UE as illustrated in FIG. 1) for channel estimation at a user side. The users 1620 then denoise the estimated channels, and then feedback the denoised estimated channels back per subband to the base station 1610. The base station 1610 up-samples the SB-level precoder to RB-level precoder. The base station then applies the precoders to each RB for enhancing the signal-to-noise ratio for downlink payload transmission. To upsample the SB-level precoder, the base station 1610 incorporates imperfect side information (e.g., UL CSI) with higher sampling rate in frequency domain than DL CSI.

As illustrated in FIG. 16, in step 1621, the user performs training signal measurement. In step 1622, the user performs channel estimation. In step 1623, the user performs denoising and down sampling. In step 1624, the user identifies the SB level precoder. And in step 1625, the user performs the quantization. In step 1612, a base station (e.g., as BS as illustrated in FIG. 1) performs training signal measurement. In step 1613, the base station performs channel estimation. In step 1614, the base station performs SB level precoder acquisition. In step 1615, the base station performs precoder up-sampling. In step 1616, the base station assigns the precoder. And in step 1617, the base station performs DL transmission.

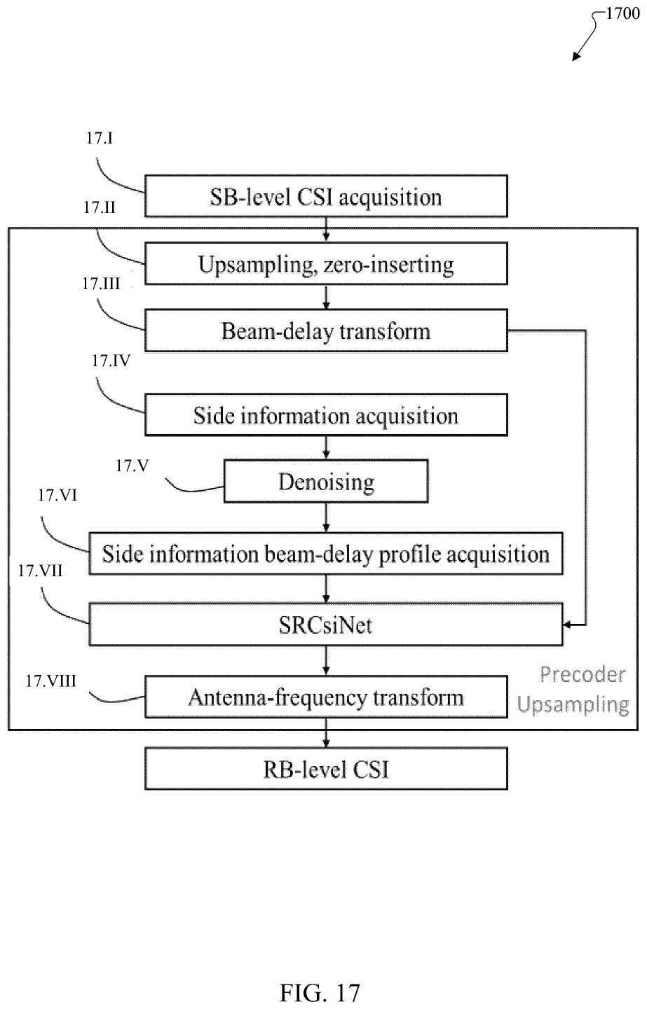

For precoder up-sampling, as shown in FIG. 17, the disclosure also adopts a denoising network applied to side information estimates against noisy environment. This denoising network helps to design a better bandpass filter in beam-delay domain by removing the noise from the noisy UL CSI estimates. This network can either be trained in an end-to-end manner to optimize the network performance or trained independently of the upsampling network to optimize the MSE of the UL CSI estimate.

FIG. 17 illustrates a flowchart of revealed learning-based precoder upsampling with UL CSI denoising 1700 according to embodiments of the present disclosure. The revealed learning-based precoder upsampling with UL CSI denoising 1700 as may be performed by a BS (e.g., 101-103 as illustrated in FIG. 1). An embodiment of the revealed learning-based precoder upsampling with UL CSI denoising 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

As illustrated in FIG. 17, in step 17.1, SB-level CSI is acquired. In step 17.11, upsampling is provided and zero-insertion is provided. In step 17.111, beam-delay transform is provided. In step 17.IV, side information is acquired. In step 17.V, denoising is performed. In step 17.VI, the side information beam-delay profile is acquired. In step 17.VII, SRCsiNet is provided. In step 17.VIII, antennal frequency transform is provided.

TABLE 4 shows the NGC performance of the baseline approach and the provided approach with imperfect DL and UL CSIs. Here there may be listed the alternatives in comparison: (1) baseline approach: denoising network+multi-RB precoding; and (2) the present disclosure with different settings includes: (i) noisy DL CSI+Noisy UL CSI, (ii) noisy DL CSI+Perfect UL CSI, (iii) denoised DL CSI+Noisy UL CSI, (iv) denoised DL CSI+Perfect UL CSI, and (v) denoised DL CSI+Denoised UL CSI.

It can easily find that the provided approach with denoised networks can outperform the baseline with designed network for different SNRs. Especially for large delay-spread samples, the provided approach can effectively suppress the aliasing effects which is the root cause of the poor performance of the baseline approach. TABLE 4. NGC performance and the improvement ratio over the baseline of the provided approach with denoised networks. It may consider non-perfect DL and UL CSI estimation with SNR from −10 dB to 10 dB.

TABLE 4. NGC performance and improvement ratio

TABLE 4
NGC performance and improvement ratio

| | ALL: CL1 + CL2 + CL3 | | | | | | CLI: DS <= 130 ns | | | | | |
|---|---|---|---|---|---|---|---|---|---|---|---|---|
| | SNR | 10 | 5 | 0 | −5 | −10 | SNR | 10 | 5 | 0 | −5 | −10 |
| | BWP = 100 MHz | | | | | | | | | | | |
| No RBs per | Baseline (NCG) | 0.91 | 0.91 | 0.90 | 0.88 | 0.84 | Baseline (NCG) | 0.98 | 0.98 | 0.97 | 0.95 | 0.91 |
| SB = 4 | Noisy dl csi + | 0.94 | 0.86 | 0.69 | 0.42 | 0.25 | Noisy dl csi + | 0.95 | 0.88 | 0.70 | 0.43 | 0.25 |
| | Noisy ul csi (NCG) | | | | | | Noisy ul csi (NCG) | | | | | |
| | Noisy dl csi + | 0.96 | 0.94 | 0.88 | 0.78 | 0.63 | Noisy dl csi + | 0.98 | 0.96 | 0.90 | 0.81 | 0.68 |
| | Perfect ul csi | | | | | | Perfect ul csi | | | | | |
| | (NCG) | | | | | | (NCG) | | | | | |
| | Denoised dl csi + | 0.97 | 0.97 | 0.96 | 0.94 | 0.89 | Denoised dl csi + | 0.99 | 0.98 | 0.98 | 0.96 | 0.92 |
| | Perfect ul csi | | | | | | Perfect ul csi | | | | | |
| | (NCG) | | | | | | (NCG) | | | | | |
| | Denoised dl csi + | 0.98 | 0.93 | 0.88 | 0.78 | 0.65 | Denoised dl csi + | 0.97 | 0.95 | 0.90 | 0.82 | 0.69 |
| | Noisy ul csi | | | | | | Noisy ul csi | | | | | |
| | (NCG) | | | | | | (NCG) | | | | | |
| | Denoised dl csi + | 0.97 | 0.97 | 0.96 | 0.93 | 0.88 | Denoised dl csi + | 0.99 | 0.98 | 0.98 | 0.96 | 0.92 |
| | Denoised ul csi | | | | | | Denoised ul csi | | | | | |
| | (NCG) | | | | | | (NCG) | | | | | |
| | Noisy dl csi + | 2.5 | −5.9 | −23.6 | −52.2 | −70.8 | Noisy dl csi + | −2.6 | −10.1 | −27.2 | −55.0 | −72.6 |
| | Noisy ul csi (% | | | | | | Noisy ul csi (% | | | | | |
| | over baseline) | | | | | | over baseline) | | | | | |
| | Noisy dl csi + | 5.2 | 2.7 | −2.8 | −12.1 | −24.8 | Noisy dl csi + | 0.00 | −2.0 | −6.5 | −14.2 | −25.3 |
| | Perfect ul csi (% | | | | | | Perfect ul csi (% | | | | | |
| | over baseline) | | | | | | over baseline) | | | | | |
| | Denoised dl csi + | 6.2 | 6.3 | 6.2 | 6.1 | 5.7 | Denoised dl csi + | 0.7 | 0.7 | 0.9 | 1.0 | 1.5 |
| | Perfect ul csi (% | | | | | | Perfect ul csi (% | | | | | |
| | over baseline) | | | | | | over baseline) | | | | | |
| | Denoised dl csi + | 4.8 | 2.1 | −2.6 | −11.4 | −22.7 | Denoised dl csi + | −0.7 | −2.8 | −6.7 | −14.0 | −23.7 |
| | Noisy ul csi (% | | | | | | Noisy ul csi (% | | | | | |
| | over baseline) | | | | | | over baseline) | | | | | |
| | Denoised dl csi + | 6.28 | 6.21 | 6.0 | 5.7 | 5.0 | Denoised dl csi + | 0.8 | −0.8 | −0.8 | 0.9 | 1.3 |
| | Denoised ul csi | | | | | | Denoised ul csi | | | | | |
| | (% over baseline) | | | | | | (% over baseline) | | | | | |

| | CL2: DS = 130-350 ns | | | | | | CL3: DS >= 350 ns | | | | | |
|---|---|---|---|---|---|---|---|---|---|---|---|---|
| | SNR | 10 | 5 | 0 | −5 | −10 | SNR | 10 | 5 | 0 | −5 | −10 |
| | BWP = 100 MHz | | | | | | | | | | | |
| No RBs per | Baseline (NCG) | 0.92 | 0.91 | 0.90 | 0.88 | 0.84 | Baseline (NCG) | 0.84 | 0.84 | −0.83 | 0.81 | 0.78 |
| SB = 4 | Noisy dl csi + | 0.9.4 | 0.86 | 0.69 | 0.42 | 0.25 | Noisy dl csi + | 0.92 | 0.83 | 0.67 | 0.41 | 0.24 |
| | Noisy ul csi (NCG) | | | | | | Noisy ul csi (NCG) | | | | | |
| | Noisy dl csi + | 0.96 | 0.93 | 0.87 | 0.77 | 0.62 | Noisy dl csi + | 0.94 | 0.91 | 0.85 | 0.74 | 0.60 |
| | Perfect ul csi | | | | | | Perfect ul csi | | | | | |
| | (NCG) | | | | | | (NCG) | | | | | |
| | Denoised dl csi + | 0.97 | 0.97 | 0.96 | 0.94 | 0.88 | Denoised dl csi + | 0.95 | 0.95 | 0.94 | 0.91 | 0.86 |
| | Perfect ul csi | | | | | | Perfect ul csi | | | | | |
| | (NCG) | | | | | | (NCG) | | | | | |
| | Denoised dl csi + | 0.96 | 0.93 | 0.88 | 0.78 | 0.64 | Denoised dl csi + | 0.94 | 0.91 | 0.85 | 0.75 | 0.62 |
| | Noisy ul csi | | | | | | Noisy ul csi | | | | | |
| | (NCG) | | | | | | (NCG) | | | | | |
| | Denoised dl csi + | 0.97 | 0.97 | 0.96 | 0.93 | 0.88 | Denoised dl csi + | 0.95 | 0.95 | 0.94 | 0.91 | 0.85 |
| | Denoised ul csi | | | | | | Denoised ul csi | | | | | |
| | (NCG) | | | | | | (NCG) | | | | | |
| | Noisy dl csi + | 2.2 | −5.5 | −23.3 | −52.3 | −70.2 | Noisy dl csi + | 9.5 | −1.2 | −19.3 | −49.4 | −69.2 |
| | Noisy ul csi (% | | | | | | Noisy ul csi (% | | | | | |
| | over baseline) | | | | | | over baseline) | | | | | |
| | Noisy dl csi + | 4.3 | 2.2 | −3.3 | −12.5 | −26.2 | Noisy dl csi + | 11.9 | 8.3 | −202.4 | −8.6 | −23.1 |
| | Perfect ul csi (% | | | | | | Perfect ul csi (% | | | | | |
| | over baseline) | | | | | | over baseline) | | | | | |
| | Denoised dl csi + | 5.4 | 6.6 | 6.7 | 6.8 | 4.8 | Denoised dl csi + | 13.1 | 13.1 | 213.3 | 12.3 | 10.3 |
| | Perfect ul csi (% | | | | | | Perfect ul csi (% | | | | | |
| | over baseline) | | | | | | over baseline) | | | | | |
| | Denoised dl csi + | 4.3 | 2.2 | −2.2 | −11.4 | −23.8 | Denoised dl csi + | 11.9 | 8.3 | −202.4 | −7.4 | −20.5 |
| | Noisy ul csi (% | | | | | | Noisy ul csi (% | | | | | |
| | over baseline) | | | | | | over baseline) | | | | | |
| | Denoised dl csi + | 5.4 | 6.6 | 6.7 | 5.7 | 4.8 | Denoised dl csi + | 13.1 | 13.1 | −213.3 | 12.3 | 9 |
| | Denoised ul csi | | | | | | Denoised ul csi | | | | | |
| | (% over baseline) | | | | | | (% over baseline) | | | | | |

To reduce a number of feedback overhead, precoders are transmitted back per SB, resulting in performance degradation in terms of channel gain in frequency selective fading channels. In some systems, a user calculates the best precoder for each SB and feedback to BS. However, it still suffers severe channel gain loss under high delay spread channels due to subband frequency spacing is too wide, leading to aliasing effects. Some approaches can apply a learning-based approach to reduce the number of precoder feedback overhead per SB by leveraging the channel sparsity in beam domain. The performance improvement is limited since it does not exploit the delay sparsity. Some approaches can apply an autoencoder structure to compress and recover the DL CSI by exploiting both the delay and beam sparsity. Yet, it still does not solve the aliasing problem caused by the low frequency placement density of CSI-RS.

Enabling new use-cases for next generation cellular networks by providing a more efficient DL CSI feedback for high DS spread scenarios or high-frequency band communications with limited feedback resources.

Enabling the co-existence of sensors in a large sensor network. For example, for future next generation self-driving systems, the mmWave radars mount on vehicles in urban area may crash due to the mutual interference.

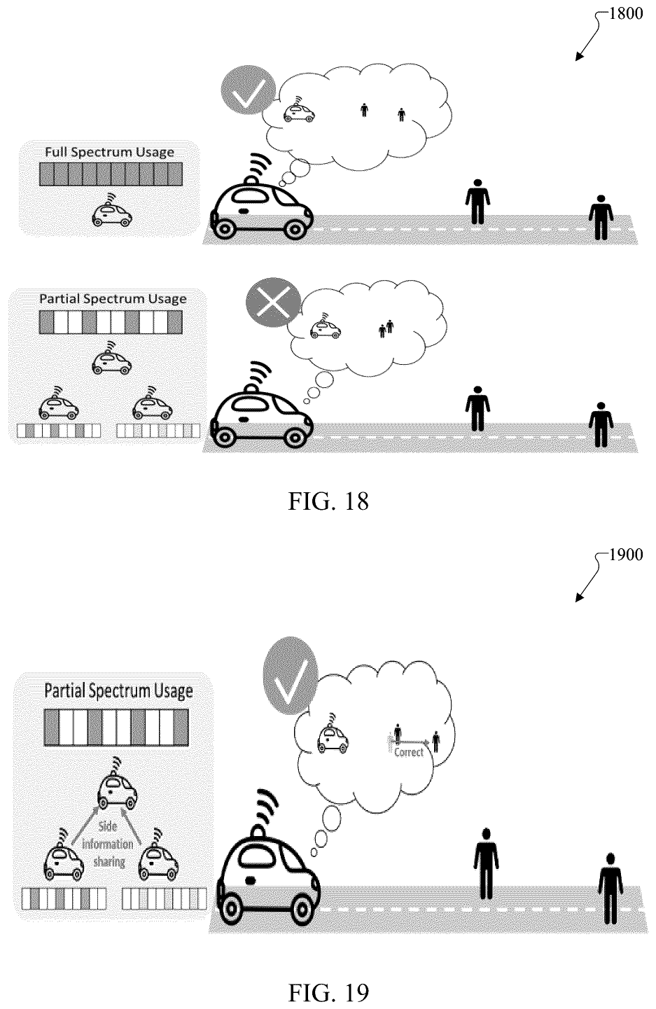

To avoid sensor network crashing, coordinated sensor network may evenly assign partial spectrum for each vehicle, leading to lower detectable distance. For objects with distance larger than the detectable distance, the so-called aliasing effect may occur and mistake far objects as near objects as shown in FIG. 18.

FIG. 18 illustrates an example of side effect of partial spectrum usage in a sensor network 1800 according to embodiments of the present disclosure. An embodiment of the side effect of partial spectrum usage in a sensor network 1800 shown in FIG. 18 is for illustration only.

By exchanging or receiving side information and apply the provided approach, the vehicle can successfully correct the wrong estimate.

FIG. 19 illustrates an example of partial spectrum for a sensor network 1900 according to embodiments of the present disclosure. An embodiment of the partial spectrum for a sensor network 1900 shown in FIG. 19 is for illustration only.

Recently, international standard group 3GPP officially mentioned AI-empowered CSI estimation/feedback as a new scenario in their new technical reports. The trend to apply Al to the next-generation communications is more popular. Moreover, the disclosure can be used to solve any aliasing issue in the field of signal processing or other fields when qualified side information is available. For example, for a scenario with dense self-driving cars, it may cause mutual interference to detect targets with full spectrums in a large mmWave radar networks. In this case, the disclosure can help to reduce the radio frequency usage for each vehicle and avoid aliasing effect occurring when detecting targets. Thus, any other telecommunication and sensor-related industries are possible to use this disclosure.

The periodic collection of DL CSI feedback and UL reference signals by a network operator can be detected. If it may be able to further discover that there exists simultaneous use of these two types of information for improving CSI feedback quality using neural networks, then such discovery will provide some clues on the potential infringement on our disclosure.

Al based air interface optimization tools are likely to be standardized in the coming years by organizations such as the O-RAN alliance and 3GPP. The description of the disclosure broadly covers the possible solutions for air interface optimization. This disclosure has the potential to impact such standards and also be considered prior art to any procedures defined by the standards. Also, in ORAN alliance specification, the interfaces between NEs and near real-time RAN intelligent controller (near-RT RIC) are standardized. It may observe the types of the information exchange between NEs and near-RT RIC via the standard interface and use them to detect potential infringement.

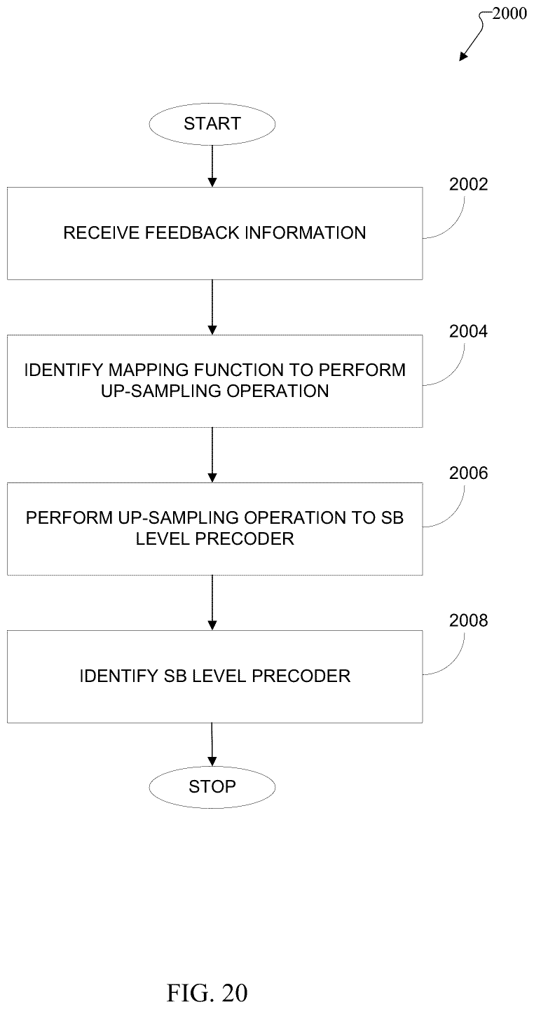

FIG. 20 illustrates a flowchart of BS method 2000 for CSI upsampling according to embodiments of the present disclosure. The BS method 2000 as may be performed by a BS (e.g., 101-103 as illustrated in FIG. 1). An embodiment of the BS method 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions.

As illustrated in FIG. 20, a method 2000 begins at step 2002. In step 2002, a BS receives, from a UE, feedback information including at least one SB level precoder.

In step 2004, the BS identifies, based on the at least one SB level precoder, a mapping function to perform an up-sampling operation.

In one embodiment, the mapping function comprises a non-linear mapping function to up-sample the at least one SB level precoder to the at least one RB level precoder, and wherein the non-linear mapping function is a multi-input non-linear function.

In one embodiment, the at least one SB level precoder includes at least one coarse-resolution precoder or CSI.

In one embodiment, the feedback information includes a precoder information that is down-sampled in accordance with a number of SBs and the feedback information is generated by a channel estimation operation, a channel denoising operation, and a precoder selection operation.

In step 2006, the BS performs, based on the mapping function, the up-sampling operation to the at least one SB level precoder.

In step 2008, the BS identifies, based on the up-sampling operation, at least one RB level precoder from the at least one SB level precoder for a precoder gain of the BS.

In one embodiment, the BS identifies side information associated with at least one of uplink CSI, historical information of the uplink CSI, distance information between the UE and the BS, and a direction of the UE and identifies, based on the side information, a filter for an aliasing suppression operation.

In one embodiment, the BS identifies at least one of precoder up-sample or CSI up-sample.

In one embodiment, the BS performs a non-aliasing selection map generation operation to obtain a true peak of signal, performs, based on the non-aliasing selection map generation operation, a true peak recovery operation to recover true and hales peaks, performs, based on the true peak recovery operation, an attention and dual refinement operation to reduce a size of convolutional filter size, and performs, based on the attention and dual refinement operation, a denoising operation to mitigate a noise of estimated downlink CSI.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive, from a user equipment (UE), feedback information including at least one subband (SB) level precoder; and
a processor operably coupled to the transceiver, the processor configured to:
identify, based on the at least one SB level precoder, a mapping function to perform an up-sampling operation,
perform, based on the mapping function, the up-sampling operation to the at least one SB level precoder, and
identify, based on the up-sampling operation, at least one resource block (RB) level precoder from the at least one SB level precoder for a precoder gain of the BS.

2. The BS of claim 1, wherein the processor is further configured to:
identify side information associated with at least one of uplink channel state information (CSI), historical information of the uplink CSI, distance information between the UE and the BS, and a direction of the UE; and
identify, based on the side information, a filter for an aliasing suppression operation.

3. The BS of claim 2, wherein the processor is further configured to identify at least one of precoder up-sample or CSI up-sample.

4. The BS of claim 2, wherein the processor is further configured to:
perform a non-aliasing selection map generation operation to obtain a true peak of signal;
perform, based on the non-aliasing selection map generation operation, a true peak recovery operation to recover true and hales peaks;
perform, based on the true peak recovery operation, an attention and dual refinement operation to reduce a size of convolutional filter size; and
perform, based on the attention and dual refinement operation, a denoising operation to mitigate a noise of estimated downlink CSI.

5. The BS of claim 1, wherein the mapping function comprises a non-linear mapping function to up-sample the at least one SB level precoder to the at least one RB level precoder, and wherein the non-linear mapping function is a multi-input non-linear function.

6. The BS of claim 1, wherein the at least one SB level precoder includes at least one coarse-resolution precoder or channel state information (CSI).

7. The BS of claim 1, wherein:
the feedback information includes a precoder information that is down-sampled in accordance with a number of SBs; and
the feedback information is generated by a channel estimation operation, a channel denoising operation, and a precoder selection operation.

8. A method of a base station (BS) in a wireless communication system, the method comprising:
receiving, from a user equipment (UE), feedback information including at least one subband (SB) level precoder;
identifying, based on the at least one SB level precoder, a mapping function to perform an up-sampling operation;
performing, based on the mapping function, the up-sampling operation to the at least one SB level precoder; and
identifying, based on the up-sampling operation, at least one resource block (RB) level precoder from the at least one SB level precoder for a precoder gain of the BS.

9. The method of claim 8, further comprising:
identifying side information associated with at least one of uplink channel state information (CSI), historical information of the uplink CSI, distance information between the UE and the BS, and a direction of the UE; and
identifying, based on the side information, a filter for an aliasing suppression operation.

10. The method of claim 9, further comprising identifying at least one of precoder up-sample or CSI up-sample.

11. The method of claim 9, further comprising:
performing a non-aliasing selection map generation operation to obtain a true peak of signal;
performing, based on the non-aliasing selection map generation operation, a true peak recovery operation to recover true and hales peaks;
performing, based on the true peak recovery operation, an attention and dual refinement operation to reduce a size of convolutional filter size; and
performing, based on the attention and dual refinement operation, a denoising operation to mitigate a noise of estimated downlink CSI.

12. The method of claim 8, wherein the mapping function comprises a non-linear mapping function to up-sample the at least one SB level precoder to the at least one RB level precoder, and wherein the non-linear mapping function is a multi-input non-linear function.

13. The method of claim 8, wherein the at least one SB level precoder includes at least one coarse-resolution precoder or channel state information (CSI).

14. The method of claim 8, wherein:
the feedback information includes a precoder information that is down-sampled in accordance with a number of SBs; and
the feedback information is generated by a channel estimation operation, a channel denoising operation, and a precoder selection operation.

15. A user equipment (UE) in a wireless communication system, the UE comprising:
a processor; and
a transceiver operably coupled to the processor, the transceiver configured to transmit, to a base station (BS), feedback information including at least one subband (SB) level precoder,
wherein:
a mapping function is identified to perform an up-sampling operation based on the at least one SB level precoder,
the up-sampling operation is performed to the at least one SB level precoder based on the mapping function, and
at least one resource block (RB) level precoder is identified from the at least one SB level precoder for a precoder gain of the BS based on the up-sampling operation.

16. The UE of claim 15, wherein:
side information is identified, the side information being associated with at least one of uplink channel state information (CSI), historical information of the uplink CSI, distance information between the UE and the BS, and a direction of the UE; and
a filter for an aliasing suppression operation is identified based on the side information.

17. The UE of claim 16, wherein:
a non-aliasing selection map generation operation is performed to obtain a true peak of signal;
a true peak recovery operation is performed to recover true and hales peaks based on the non-aliasing selection map generation operation;
an attention and dual refinement operation is performed to reduce a size of convolutional filter size based on the true peak recovery operation; and
a denoising operation is performed to mitigate a noise of estimated downlink CSI based on the attention and dual refinement operation.

18. The UE of claim 15, wherein the mapping function comprises a non-linear mapping function to up-sample the at least one SB level precoder to the at least one RB level precoder, and wherein the non-linear mapping function is a multi-input non-linear function.

19. The UE of claim 15, wherein: the at least one SB level precoder includes at least one coarse-resolution precoder or channel state information (CSI).

20. The UE of claim 15, wherein:
the feedback information includes a precoder information that is down-sampled in accordance with a number of SBs; and
the feedback information is generated by a channel estimation operation, a channel denoising operation, and a precoder selection operation.
